(19) United States
(12) Patent Application Publication
(10) Pub. No.: US 2002/0055340 A1
(43) Pub. Date: May 9, 2002

(54) Automatic program arrangement apparatus and method

(75) Inventors: Fumio Seto, Kanagawa-ken (JP); Masayuki Takada, Gunma-ken (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 09/984,749

(22) Filed: Oct. 31, 2001

(30) Foreign Application Priority Data
Nov. 8, 2000 (JP) P2000-340546

(51) Int. Cl. H04B 7/00

(52) U.S. Cl. 455/186.1; 455/45

(57) ABSTRACT

An apparatus and method for automatically arranging a program plan are disclosed as including a program plan arrangement section, which determines pertinent broadcasting stations, from which broadcasting radio waves are received, at respective locations on a selected route connected to the destination, on the basis of program tables of various broadcasting stations on the selected route, programs covering user's favorite genre and the current time at which the program plan is arranged, and arranges the relevant program plan. Based on such a program plan, an output changeover unit automatically changes over the broadcasting radio waves to be received by a receiver unit, in dependence on moving object's locations on the selected route, to allow the selected broadcasting programs to be outputted.

### BACKGROUND OF THE INVENTION

The present invention relates to an automatic program arrangement apparatus and a method, and more particularly relates to an automatic program arrangement apparatus of a moving object to arrange a program of a broadcasting station while automatically changing over broadcasting radio waves acquired at various locations on a selected route from the current position to the destination, to a desired program of a broadcasting station reflecting a user's favorite genre, and also relates to a method of arranging the program of the broadcasting station.

It has been proposed to provide an automatic program arrangement apparatus which is structured so as to automatically search for broadcasting programs, covering user's favorite genre, to be displayed over a display monitor without requiring the user's complicated operation, as disclosed in Japanese Patent Application Laid-Open Publication No. 2000-115098.

### SUMMARY OF THE INVENTION

However, in such an automatic program arrangement apparatus, since broadcasting stations change in dependence on locations on the selected route when the moving object passes across various areas, it is necessary for the broadcasting program to be re-arranged, with a resultant difficulty caused when installing such an apparatus in the moving object.

The present invention has been made with such a view and has an object to provide an automatic program arrangement apparatus automatically arranging and changing over broadcasting programs for a moving object to cover a user's favorite genre and to be outputted in each of locations on a selected route connected from the current position to the destination, and to provide a method of automatically arranging and changing over the broadcasting programs.

According to one aspect of the present invention, there is provided an automatic program arrangement apparatus of a moving object, which comprises: a receiver unit receiving broadcasting radio waves to acquire broadcasting data; a broadcasting area storage unit storing broadcasting area information covering a plurality of broadcasting stations from which respective broadcasting radio waves are receivable; a navigation unit outputting route information related to a destination, a current position and current time; a program acquisition unit acquiring and holding program tables of respective broadcasting stations on a selected route connected to the destination, on the basis of route information acquired from the navigation unit and broadcasting area information stored in the broadcasting area storage unit; a genre setting unit presetting a genre of programs to be acquired; a program plan arrangement section determining relevant broadcasting stations to be received on respective locations of the selected route connected to the destination to arrange a program plan, on the basis of the program tables held in the program acquisition unit, the genre of the programs held by the genre setting unit, and the current time at which the program plan is arranged; and an output changeover unit changing over the broadcasting radio waves to be received by the receiver unit on the basis of the program plan.

In other words in the present invention, an automatic program arrangement apparatus of a moving object is provided with: first acquiring means for acquiring broadcasting data; storing means for storing broadcasting area information covering a plurality of broadcasting for stations from which respective broadcasting radio waves are receivable; outputting means for outputting route information related to a destination, a current position and current time; second acquiring means for acquiring and holding program tables of respective broadcasting stations on a selected route connected to the destination, on the basis of route information acquired from the outputting means and broadcasting area information stored in the storing means; presetting means for presetting a genre of programs to be acquired; determining means for determining relevant broadcasting stations on respective locations of the selected route connected to the destination to arrange a program plan, on the basis of the program tables held by the second acquiring means, the genre of the programs held by the presetting means, and the current time at which the program plan is arranged; and changing over means for changing over the broadcasting radio waves to be received by the first acquiring means on the basis of the program plan.

Besides in the present invention, a method of arranging a program of a moving object acquires broadcasting data; stores broadcasting area information covering a plurality of broadcasting stations from which respective broadcasting radio waves are receivable; outputs route information related to a destination, a current position and current time; acquires and holds program tables of respective broadcasting stations on a selected route connected to the destination, on the basis of the route information and the broadcasting area information; presets a genre of programs to be acquired; determines relevant broadcasting stations on respective locations of the selected route connected to the destination to arrange a program plan, on the basis of the program tables, the genre of the programs, and the current time at which the program plan is arranged; and changes over the broadcasting radio waves to be received on the basis of the program plan.

Other and further features, advantages, and benefits of the present invention will become more apparent from the following description taken in conjunction with the following drawings.

### BRIEF DESCRIPTION OF THE DRAWINGS

FIG. 1 is a block diagram of an automatic program arrangement apparatus of one embodiment according to the present invention;

FIG. 2 is a flow chart illustrating the basic sequence of main operational steps for the automatic program arrangement apparatus shown in FIG. 1 to carry out a method of the present invention;

FIG. 3 is a flow chart illustrating the basic sequence of main operational steps to execute a program arrangement process shown in FIG. 2; and

FIG. 4 is a flow chart illustrating the basic sequence of main operational steps to execute a broadcasting-station changing-over process shown in FIG. 2.

### DETAILED DESCRIPTION OF THE PREFERRED EMBODIMENTS

To describe the present invention more in detail, an automatic broadcasting program arrangement apparatus of one typical embodiment of the present invention to implement a method for automatically arranging a broadcasting program will be explained with reference to the drawings below.

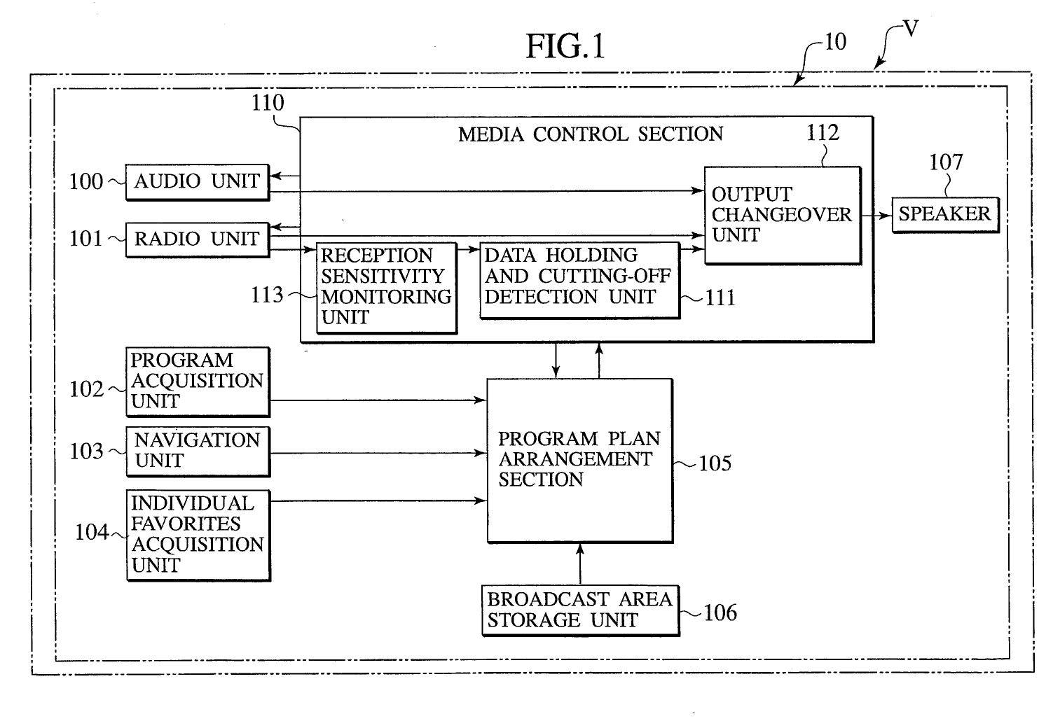

Referring to FIG. 1, there is shown an automatic broadcasting program arrangement apparatus 10, which is applied to a moving object such as a vehicle V, of the present embodiment according to the present invention. The automatic broadcasting program arrangement apparatus 10 includes an audio player unit 100, a radio receiver unit 101 which receives a radio broadcast, a program acquisition unit 102, a navigation unit 103, an individual favorites acquisition unit 104, a program plan arrangement section 105, a broadcasting area storage unit 106, a speaker 107 and a media control section 110.

The audio player unit 100 functions to reproduce a music item from an audio recording medium, in which sound data is recorded, such as MD (minidisk : magneto optical recording medium), CD (compact disk: optical recording medium), DVD (digital versatile disk: optical recording medium), a cassette tape (magnetic recording medium) or a semiconductor memory. The radio receiver unit 101 functions to receive AM and FM broadcasting radio waves at various frequencies and to convert these broadcasting radio waves into audio data to be outputted to the media control section 110.

The program acquisition unit 102 functions to acquire program tables, from a large number of broadcasting station, which are disclosed through an information network such as the Internet, for transmitting these program tables to the program arrangement section 105. The navigation unit 103 has functions to detect the current position of the moving object, which carries the automatic program arrangement apparatus 10, to measure the current time, and to automatically search for a recommended route connected to the destination from the current position when a user inputs a search command for a desired route while presetting the destination on a map displayed on a display monitor of the navigation unit 103 so as to provide such information to the user. The navigation unit 103 transmits such searched rout information as data to the program arrangement section 105.

The individual favorites acquisition unit 104 serves as a genre presetting unit to preliminarily acquire genre of individual favorite programs of the user for holding the same and to output the acquired genre as genre information to the program plan arrangement section 105. The individual favorite genre is enabled to be designated in terms of a general expression such as a sport relay genre, a music genre or news genre, or the like. Also, such an individual favorite genre is enabled to be more precisely designated such as a baseball relay broadcast or a succor relay broadcast in the sport relay genre, names of the artists, pop, new music or classic in the music genre, and a usual news or sport news in the news genre, or the like.

The program plan arrangement section 105, in response to the route information for the destination received from the navigation unit 103, functions to determine a broadcasting station information (frequency information) which can be received at various points on the selected route by referring to broadcasting area information stored in the broadcasting area storage unit 106, to receive program table information from a large number of the broadcasting stations inputted from the program acquisition unit 102, to determine broadcasting station and broadcasting programs to be received at respective locations on the selected route during the traveling of the moving object in a time interval between the current time at the current position and the time at which the moving object arrives at the destination; and to specify the broadcasting programs covering the individual favorite genre further on the basis of information delivered from the individual favorites acquisition unit 104 for arranging a program plan to be received for the user. The broadcasting area storage unit 106 functions to store broadcasting area information related to various broadcasting stations and to output broadcasting area information to the program plan arrangement section 105.

The media control section 110 is structured as having a data holding and cutting-off point detection unit 111, an output changeover unit 112, and a receiving sensitivity monitoring unit 113. In such a media control section 110, the data holding and cutting-off point detection unit 111 has a first function to acquire, store and delete voice data, a second function to recognize “music” from voice data when there exists a larger difference in sound pressure variations of the voice data, for example, between left and right channels, and to recognize “talking” when there exists a smaller difference in the aforementioned sound pressure variations, a third function to detect a cutting-off point between “music” and “talking”, and a fourth function to discriminate from voice data whether the broadcasting radio wave is reliably received.

In the media control section 110, the output changeover unit 112 responds to received program-plan information arranged by the program arrangement section 105 and has a first function to changeover frequency of the broadcasting radio wave, to be received at the radio receiver unit 101, a second function to change over the radio receiver unit 101 to the audio player unit 100 for introducing voice data when the receiving sensitivity of the broadcasting radio wave is poor, a third function to change over broadcasting voice data between broadcasting stations at a desired cutting-off point based on the cutting-off detection signal delivered from the data holding and cutting-off point detection unit 111, a fourth function to execute the changeover between broadcasting voice data and audio voice data, and a fifth function to convert voice data, which is inputted, into a voice to be outputted from the speaker 107.

The receiving sensitivity monitoring unit 113 functions to monitor the receiving sensitivity of the radio wave which is received by the radio receiver unit 101.

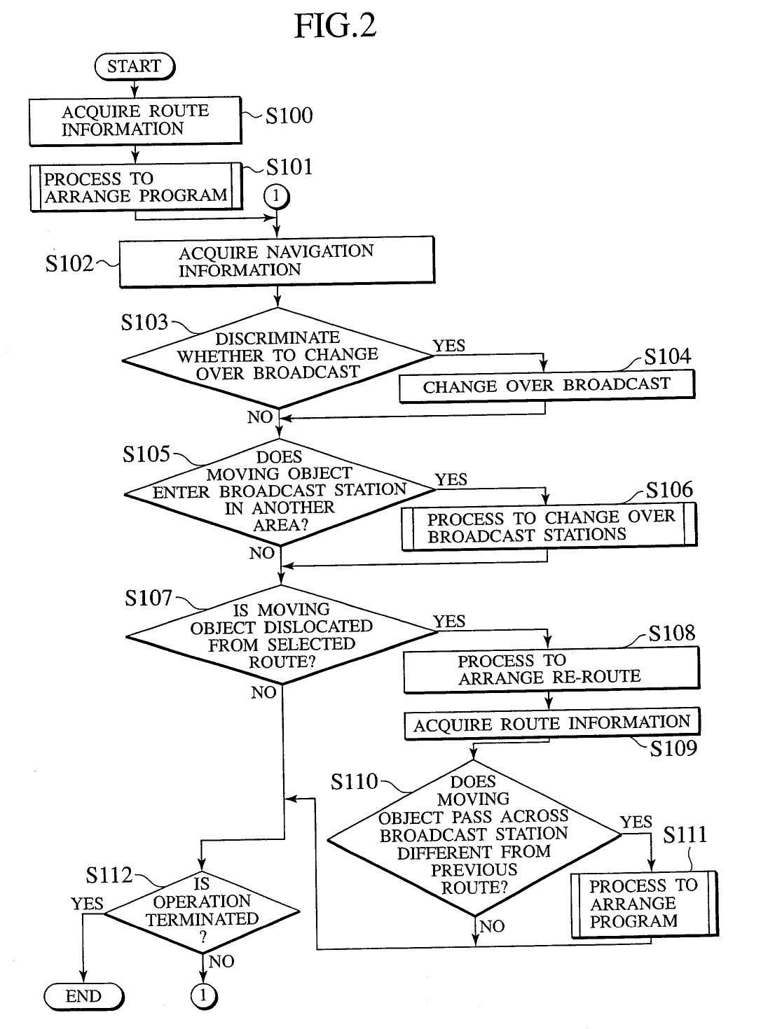

FIGS. 2 to 4 show a flow diagram of the main sequence or the like of operational steps for the automatic program arrangement apparatus of the present embodiment to carry out the method of the present invention.

Initially, a main processing operation of the apparatus is described with reference to FIG. 2. First, the destination is preset in the navigation unit 103 to search for a desired route for thereby determining a recommended route, of which information is introduced into the program plan arrangement section 105 in step S100. In step S101, the program plan arrangement section 105 executes a processing step to arrange a program based on route information which is produced in step S100, thereby forming a program plan covering the user's individual favorite genre.

In the consecutive step S102, the program plan arrangement section 105 acquires navigation information, such as the current position and the current time, from the navigation unit 103. In step S103, the program plan arrangement section 105 discriminates whether to change over broadcast when, in the program plan, the current time reaches the closing time of the broadcasting program, and in step S104, issues a command to the media control section 110 whether to execute either an acquiring step of a subsequent program in the same broadcasting station, an acquiring step of the broadcasting radio wave of another broadcasting station or an audio reproduction step, on the basis of the program plan.

In the next step S105, the program plan arrangement section 105 discriminates, in the presence of current position data acquired from the navigation unit 103 and on the basis of information from the broadcasting area storage unit 106, whether the moving object enters a new broadcasting area of another broadcasting station. When this occurs, in step S106, the program plan arrangement section 105 executes to change over the broadcasting stations.

In step S107, the program plan arrangement section 105 discriminates whether the area which the moving object travels is dislocated from the recommended route. When this occurs, the user commands the navigation unit 103 to search for a new recommended route (re-route) to set the new recommended route to the destination again in step S108.

Upon completion of the re-route processing step, the program plan arrangement section 105 acquires route information again from the navigation unit 103 in step S109. Then, in step S110, the program plan arrangement section 105 judges, by referring to broadcasting area information delivered from the broadcasting area storage unit 106, whether to pass across the broadcasting area which is different from the previous route. When judgment is made to pass across the broadcasting area of the broadcasting station different from that of the previous route such as initially selected route in step S110, the program plan arrangement section 105 re-executes, in step 111, the processing step for arranging the program on the basis of new route information accessible to the destination which has been preset in the route processing step, such that only program segments, which are different from those of the previous program plan on the previous route and relate to the broadcasting stations not included in the previous program plan, replace such previous program segments of the previous program plan.

When the moving object has arrived at the destination or when a main switch of the moving object is turned off, the program plan arrangement section 105 judges that the operation is terminated and, when the operation is not terminated, the aforementioned steps S102 to S111 are repeatedly executed in step S112.

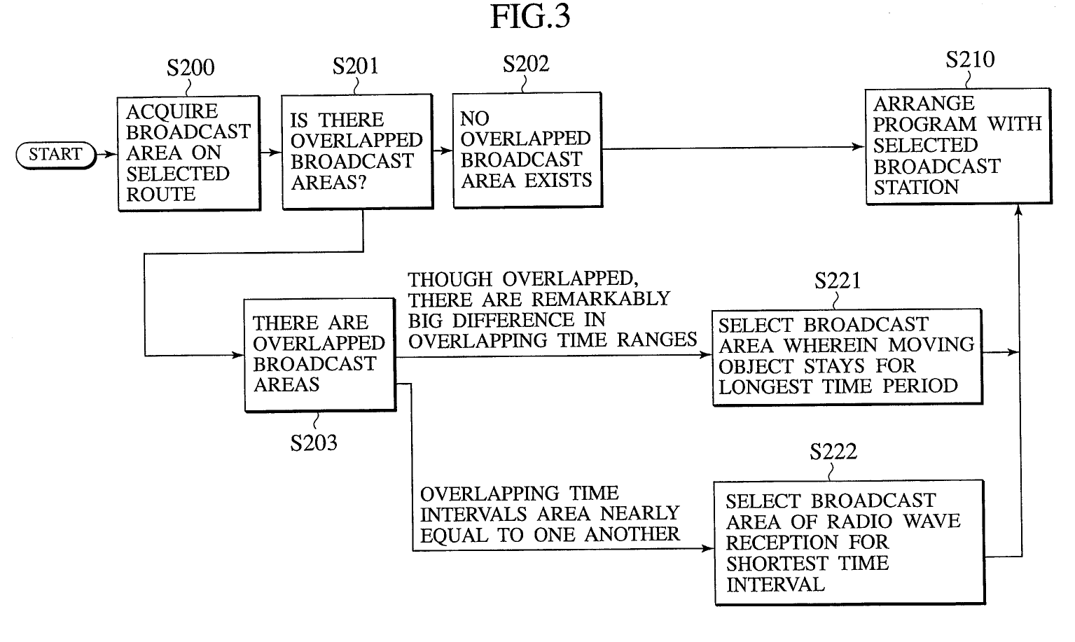

The program plan arrangement process in steps S101 and S111 in the main processing operation shown in FIG. 2 is described below in detail in conjunction with a flow chart of FIG. 3. In FIG. 3, at the start, the program arrangement section 105 begins to process for arranging the program plan. In step S200, the program plan arrangement section 105 acquires broadcasting area data of the route from the broadcasting area storage unit 106 on the basis of route information obtained from the navigation unit 103. In this instance, the program plan arrangement section 105 judges whether there are overlapped broadcasting areas of the different broadcasting stations on the selected route in step S201. In the absence of the overlapped broadcasting areas (in step S202), the program plan arrangement section 105 arranges the program and holds it as the program plan, on the basis of broadcasting area data obtained in step S200 and user's favorite genre information obtained from the individual favorites acquisition unit 104. At this instant, in the absence of the broadcasting program covering user's favorite genre information, the program plan arrangement section 105 arranges the program so as to be changed over to an audio reproduction mode using the audio player for a traveling distance of the relevant route in which the broadcasting program covering user's favorite genre information is not found out. Upon completion of arranging the program plan, the program arrangement section 105 issues a command to the media control section 110 to allow a first and foremost broadcasting program to be outputted in step 210.

In the presence of the overlapped broadcasting areas of the different broadcasting stations on the selected route, in step S203, the program plan arrangement section 105 discriminates whether the time intervals for which the radio waves are continued to be received on the selected route are remarkably different from one another. In case where there is a remarkable difference in time interval for which the radio waves are enabled to be continuously received, the program plan arrangement section 105 selects the broadcasting station from which the radio wave is received for the longest time interval, in step S221, thereby arranging the program plan in step S209. On the contrary, in case where there are overlapped broadcasting areas of the different broadcasting stations on the selected route and where the radio waves can be continuously received from the different broadcasting stations for substantially the same time interval, the program plan arrangement section 105 selects the broadcasting station which enables the changeover between the previously available broadcasting station from which the radio wave is received and a subsequently available broadcasting station in the shortest time period, in step S222, thereby arranging the program plan in step S210. The aforementioned program arrangement process will be repeatedly executed until the moving object travels from the current position to the destination on the selected route.

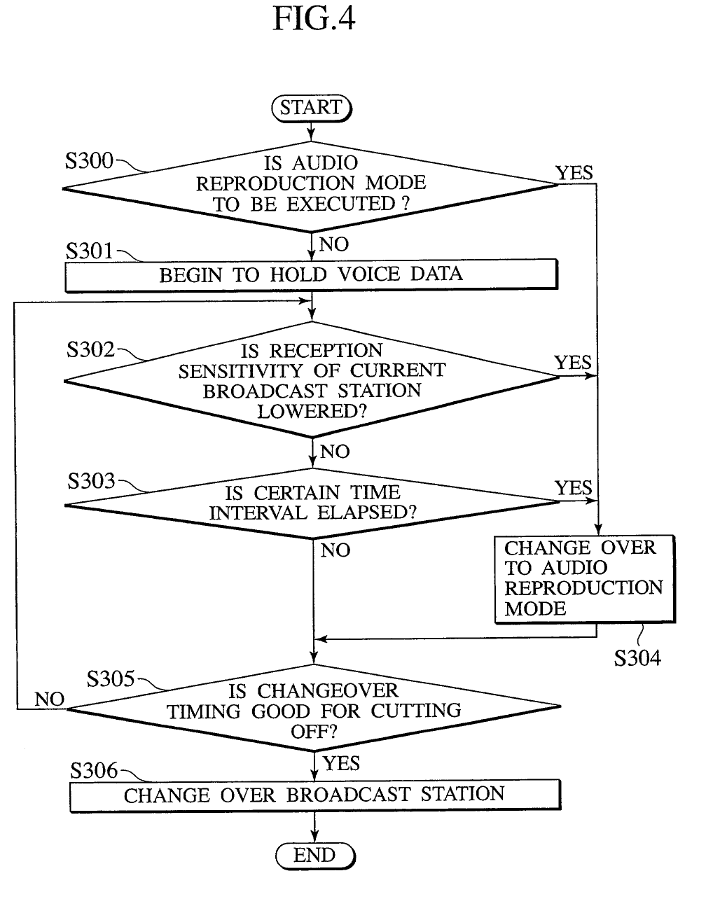

Now, a process for changing over the broadcasting stations in step S106 in a main processing operation shown in FIG. 2 is described with reference to FIG. 4. First, in step S300, the media control section 110 judges whether to change over the previous mode to the audio reproduction mode, for example, in response to user's operation. When it is judged that the previous mode is changed over to the audio reproduction mode, the media control section 110 commands to the audio player unit 100 to execute the audio reproduction while allowing the output changeover unit 112 to be caged over to the audio reproduction mode and allowing voice data to be converted to the voice to be outputted from the speaker 107 in step S304.

In step S300, if the media control section 110 does not judge to execute the audio reproduction mode, then the data holding and cutting-off point detection unit 111 acquires voice data of the broadcasting program of the broadcasting station which is the target to be changed over by the radio receiver unit 101 and begins to hold such a voice data in step S301.

Consecutively, when the receiving sensitivity of the radio wave currently transmitted from the broadcasting station becomes remarkably poor, the media control section 110 immediately changes over to the audio reproduction mode in steps S302, S304. In step S302, however, when it is judged that the receiving sensitivity of the radio wave of the currently available broadcasting station is not lowered, the media control section 110 judges whether a given time period has elapsed after commencing the changing over processing of the broadcasting station in step S303.

Here, in case where the given time period has not elapsed, the media control section 110 consecutively outputs the broadcasting program of the broadcasting station to be changed over in step S305 until a good point to cut off the broadcasting program of the broadcasting station to be changed over is found. On the contrary, in case where the good point to cut off the broadcasting program of the broadcasting station to be changed over is not found even when the given time period has elapsed, the media control section 110 executes the changeover to the audio reproduction mode and waits for the good timing for cutting off the broadcasting program in steps S305, S303, S304.

In step S306, when it is judged that the good point for cutting off the program of the broadcasting station is found in step S305, the media control section 110 commands to the radio receiver unit 101 so as to allow the program to be changed over to the broadcasting radio wave of the subsequently available broadcasting station.

Incidentally, the above-mentioned broadcasting stations may include those affiliated with each other typically to have different broadcasting area from each other but to broadcast the same program at the same time, and such affiliated broadcasting stations may be sequentially changed over each as the available broadcasting stations, for example, having the adjacent broadcasting areas to each other.

In such a structure, an important advantage of the automatic program arrangement apparatus of the present embodiment concerns the navigation function wherein searching for the recommended route to the destination from the current position, presetting the user's favorite genre and presetting the departure time at the current position allow the apparatus to select the optimum broadcasting station which automatically broadcasts the program covering the user's favorite genre in the course of traveling through the various locations on the selected route, thereby permitting the user to listen to the desired program. Further, in a location where the receiving sensitivity of the broadcasting radio wave is poor or in a location where a difficulty is encountered in receiving the user's favorite broadcasting program, the audio player unit is enabled to reproduce the user's favorite music to which the user listens.

Further, in a case where there are plurality of broadcasting stations which cover the same location on the selected route, the selection of the desired broadcasting station is performed such that the desired broadcasting station covers the longest area, minimizing the frequency in changing over the broadcasting stations for thereby allowing the user to continuously listen to his favorite broadcasting program for an extended time period. In addition, when changing over the broadcasting stations, the changeover operation is performed at a selected timing to cut off the broadcasting programs at the good point to avoid the differential feeling, in the broadcasting content, to be given to the user after the changeover operation has been completed. Furthermore, when it is founded that there are overlapped broadcasting stations which cover the same area on the selected route, the apparatus of the present invention selects the broadcasting station which needs a little variation in frequency between the currently receiving broadcasting radio wave and the radio wave of the broadcasting station to be changed over and which enables the changeover of the broadcasting stations in the short time period, thereby enabling the changeover of the broadcasting stations in the shortest interruptive time interval.

In the present embodiment discussed above, while the apparatus of the present invention has been described with respect to the basic concept for searching the recommended route, presuming time at which the moving object passes across respective locations on the selected route on the basis of the current time at the current position and executing the changeover of the broadcasting areas at the timing on the time axis, there is a few instances wherein the presumed time is remarkably different from the actual time at which the moving object passes across the respective locations on the selected route, owing to traffic jam or other reasons. In such instances, since the intended time zone is off from the time zone in which an original broadcasting program is expected to be received, the actual broadcasting program tends to have the content which is far from the user's favorite genre.

To address such a matter, the program plan arrangement section 105 functions to acquire current position information from the navigation unit 103 in a repetitive manner, to acquire program information, from the program acquisition unit 102, which is receivable from the broadcasting station at the current time, and to search for the broadcasting station which is broadcasting the program covering the user's favorite genre which is designated by the individual favorites acquisition unit 104. With such function, when the relevant broadcasting station is found, the program arrangement section 105 also functions to changeover the previous broadcasting station to the relevant broadcasting station to receive the desired broadcasting program. Further, if there is no broadcasting program covering the user's favorite genre, the program plan arrangement section 105 may change over the broadcasting program to the audio reproduction mode. In alternative way, the program plan arrangement section 105 may be combined with an input device for re-arrangement of the program plan to allow the user to command such re-arrangement such that the aforementioned automatic program arrangement is re-executed.

In addition, in the present embodiment discussed above, while the radio receiver unit 101 which receives the radio broadcast is typically used, it is needless to say that another type of receiver unit such as a TV (television) receiver unit which receives a TV broadcast may be used instead of the radio receiver unit 101 or in combination therewith.

The entire content of a Patent Application No. TOKUGAN 2000-340546 with a filing date of Nov. 8, 2000 in Japan is hereby incorporated by reference.

Although the invention has been described above by reference to a certain embodiment of the invention, the invention is not limited to the embodiment described above. Modifications and variations of the embodiment described above will occur to those skilled in the art, in light of the teachings. The scope of the invention is defined with reference to the following claims.

What is claimed is:

1. An automatic program arrangement apparatus of a moving object, comprising:
a receiver unit receiving broadcasting radio waves to acquire broadcasting data;
a broadcasting area storage unit storing broadcasting area information covering a plurality of broadcasting stations from which respective broadcasting radio waves are receivable;
a navigation unit outputting route information related to a destination, a current position and current time;
a program acquisition unit acquiring and holding program tables of respective broadcasting stations on a selected route connected to the destination, on the basis of route information acquired from the navigation unit and broadcasting area information stored in the broadcasting area storage unit;
a genre setting unit presetting a genre of programs to be acquired;
a program plan arrangement section determining relevant broadcasting stations to be received on respective locations of the selected route connected to the destination to arrange a program plan, on the basis of the program tables held in the program acquisition unit, the genre of the programs held by the genre setting unit, and the current time at which the program plan is arranged; and
an output changeover unit changing over the broadcasting radio waves to be received by the receiver unit on the basis of the program plan.

2. An automatic program arrangement apparatus according to claim 1, wherein the program plan arrangement section determines the broadcasting radio waves to be received at the respective locations so as to allow the relevant broadcasting radio wave to be changed over to a broadcasting radio wave transmitted from a broadcasting station affiliated with a previously available broadcasting station from which a previous broadcasting radio wave has been received.

3. An automatic program arrangement apparatus according to claim 1, wherein when there are plurality of the broadcasting stations to be changed over, the program plan arrangement section arranges the program plan so as to receive a broadcasting radio wave of a broadcasting station which is receivable for the longest time period, on the basis of the route information connected to the destination and the broadcasting area information stored in the broadcasting area storage unit.

4. An automatic program arrangement apparatus according to claim 1, wherein when there are plurality of the broadcasting stations to be changed over and the time intervals in which the moving object stays in areas which the moving object receives the radio waves are substantially equal to one another on the basis of the route information connected to the destination and the broadcasting area information stored in the broadcasting area storage unit, the program plan arrangement section arranges the program plan so as to receive a broadcasting radio wave of a broadcasting station which requires the shortest time period for changing over the broadcasting radio waves.

5. An automatic program arrangement apparatus according to claim 1, further comprising an audio player unit,
wherein in the absence of the broadcasting station to be changed over on the basis of the route information connected to the destination and the broadcasting area information stored in the broadcasting area storage unit, the program plan arrangement section arranges the program plan to incorporate an audio player mode to be performed by the audio player unit,
and wherein the output changeover unit executes changeover for the broadcasting radio wave on the basis of the program plan and executes changeover for the audio reproduction mode.

6. An automatic program arrangement apparatus according to claim 5, wherein the audio player is an optical reproduction device, a magneto optical reproduction device, a magnetic reproduction device or a reproduction device using a semiconductor memory.

7. An automatic program arrangement apparatus according to claim 1, further comprising a data holding and cutting-off discriminating unit holding the broadcasting data acquired from the receiver unit and discriminating a cutting-off point between “music” and “talking” on the basis of sound pressure variations in the broadcasting data held in the data holding and cutting-off discriminating unit,
wherein the output changeover unit executes changeover for the broadcasting radio wave at a timing which the data holding and cutting-off discriminating unit detects the cutting-off point during the changeover of the broadcasting radio waves.

8. An automatic program arrangement apparatus according to claim 6, further comprising and an audio player unit and a receiving sensitivity monitoring unit monitoring receiving sensitivity of the broadcasting radio waves to be received by the receiver unit,
wherein when the receiving sensitivity of the broadcasting radio waves which are currently received and which are monitored by the receiving sensitivity monitoring unit remains at a low level to disenable the cutting-off point of the broadcasting radio waves to be detected, the output changeover unit changes over the program plan to an audio reproduction mode to be performed by the audio player unit.

9. An automatic program arrangement apparatus according to claim 1, wherein the navigation unit executes re-search for a new route when the moving object is dislocated from a previously selected route connected to the destination, and the program plan arrangement section updates the program plan with respect to only a program segment which is different from that of the broadcasting station on the initially selected route.

10. An automatic program arrangement apparatus of a moving object, comprising:
first acquiring means for acquiring broadcasting data;
storing means for storing broadcasting area information covering a plurality of broadcasting for stations from which respective broadcasting radio waves are receivable;
outputting means for outputting route information related to a destination, a current position and current time;
second acquiring means for acquiring and holding program tables of respective broadcasting stations on a selected route connected to the destination, on the basis of route information acquired from the outputting means and broadcasting area information stored in the storing means;
presetting means for presetting a genre of programs to be acquired;
determining means for determining relevant broadcasting stations on respective locations of the selected route connected to the destination to arrange a program plan, on the basis of the program tables held by the second acquiring means, the genre of the programs held by the presetting means, and the current time at which the program plan is arranged; and
changing over means for changing over the broadcasting radio waves to be received by the first acquiring means on the basis of the program plan.

11. A method of arranging a program of a moving object, comprising:
acquiring broadcasting data;
storing broadcasting area information covering a plurality of broadcasting stations from which respective broadcasting radio waves are receivable;
outputting route information related to a destination, a current position and current time;
acquiring and holding program tables of respective broadcasting stations on a selected route connected to the destination, on the basis of the route information and the broadcasting area information;
presetting a genre of programs to be acquired;
determining relevant broadcasting stations on respective locations of the selected route connected to the destination to arrange a program plan, on the basis of the program tables, the genre of the programs, and the current time at which the program plan is arranged; and
changing over the broadcasting radio waves to be received on the basis of the program plan.
